(19) United States
(12) Patent Application Publication
(10) Pub. No.: US 2006/0172267 A1
(43) Pub. Date: Aug. 3, 2006

(54) Input device training and automatic assignment

(75) Inventor: Brien T. Roell, Seattle, WA (US)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Redmond, WA (US)

(21) Appl. No.: 11/045,079

(22) Filed: Jan. 31, 2005

(51) Int. Cl. G09B 19/00

(52) U.S. Cl. 434/118

(57) ABSTRACT

Computer-implemented methods for providing input device training to a user are disclosed. A user's inputs (e.g., mouse clicks, key presses, etc.) are analyzed in order to determine optimal inputs and provide feedback to the user about optimal inputs. In addition, if a user may benefit from the assignment of frequently used inputs to an unused shortcut or button, a method is disclosed for automatically making such an assignment and alerting the user to the assignment.

### FIELD OF THE INVENTION

This invention relates generally to managing input to computers. More particularly, aspects of the invention are directed to training users on more efficient use of input devices for directing input to a computer.

### BACKGROUND OF THE INVENTION

Modern computers provide users a wide variety of methods and devices for providing input. The input provided to a computer may include selecting and launching an application from an operating system, opening a document within an application, typing a letter into a word processor application, or selecting colors in a drawing application. Input devices that make these inputs possible may include mice, keyboards, trackballs, game pads, digitizers, and so forth. Each of these input devices may provide any number of input components (e.g., keys on a keyboard, buttons on a mouse, etc.) allowing for an almost infinite range of possible interactions between a user and a computer.

Over the years, additional input components have been added to input devices to help users provide input to a computer more efficiently. For example, the scroll wheel on a mouse is commonly assigned the ability to scroll through a page or a list, allowing a user to avoid using a keyboard. Also, the F-keys on a keyboard (F1, F2, F3 . . . ) may be enabled to allow users to perform common or complex tasks with the press of a single button. Such input components may have actions assigned by the computer or sometimes by the user, and each assigned action may work in different contexts, for example globally within an operating system or only within a specific application. By providing additional input components that allow for more efficient input entry, computer users save time and are subsequently more productive.

As input components have been added, an ever expanding variety of enhanced input devices (e.g., three-, four-, and five-button mice and specialized keyboards) have been created, each for a different purpose. As a result, users moving between computers or purchasing a new input device may be unfamiliar with such enhancements and as a result lose out on potential gains in productivity. For example, a user who never realizes that a frequently used web page can be opened automatically with a special hotkey may waste time constantly drilling through menus with a mouse to get to the same web page. Sometimes, even when a user knows of the functionality tied to a particular input component, they may find no occasion to use it, and subsequently the input component may go unused and eventually forgotten.

It would be an enhancement for users of computer input devices to be notified that a particular action has been assigned to a particular input component, and that they can save time by using it. It would be a further enhancement for frequently used actions to be automatically assigned to unused input components, and for users to be notified that such an assignment is made.

### SUMMARY OF THE INVENTION

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the more detailed description below.

A first aspect of the invention provides input device training to a user. An input directed to an input device, such as a mouse, a keyboard, or a touchpad, is received and interpreted as to what action the user input requests. If an alternate input is determined that performs the requested action, then the user is alerted to the alternate input and optionally provided training on the alternate input.

A second aspect of the invention provides for assigning a frequently used input or combination of inputs to an available input component, such as a button, a key, or a combination of keys. Received inputs are stored, such as in a database. Frequently used inputs or input combinations are sought in the database. If found, the input or input combination is assigned to an input component (such as an unused input component), and the user is alerted to the assignment.

A third aspect of the invention provides a system for providing input device training.

The system includes a computer associated with storage (such as a database), a display device, and an input device. The computer is adapted to receive inputs from the input device, interpret actions based on the inputs, store the inputs in the storage, and search the storage for a pattern of input device usage. If an alternate input can optimally accomplish the same action, the user is alerted by displaying feedback on the display device.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 is a functional block diagram of an operating environment that may be used for one or more aspects of an illustrative embodiment of the invention.

FIGS. 2-5 depict feedback dialogs displayed by one or more aspects of illustrative embodiments of the invention.

FIG. 6 is a flowchart of a method for providing input device training to a user according to one or more aspects of an embodiment of the invention.

FIG. 7 is a flowchart of a method for assigning a frequently used interaction according to one or more aspects of an embodiment of the invention.

### DETAILED DESCRIPTION OF ILLUSTRATIVE EMBODIMENTS

In the following description of various illustrative embodiments, reference is made to the accompanying drawings, which form a part hereof, and in which are shown by way of illustration various embodiments in which the invention may be practiced. It is to be understood that other embodiments may be utilized and structural and functional modifications may be made, without departing from the scope and spirit of the present invention.

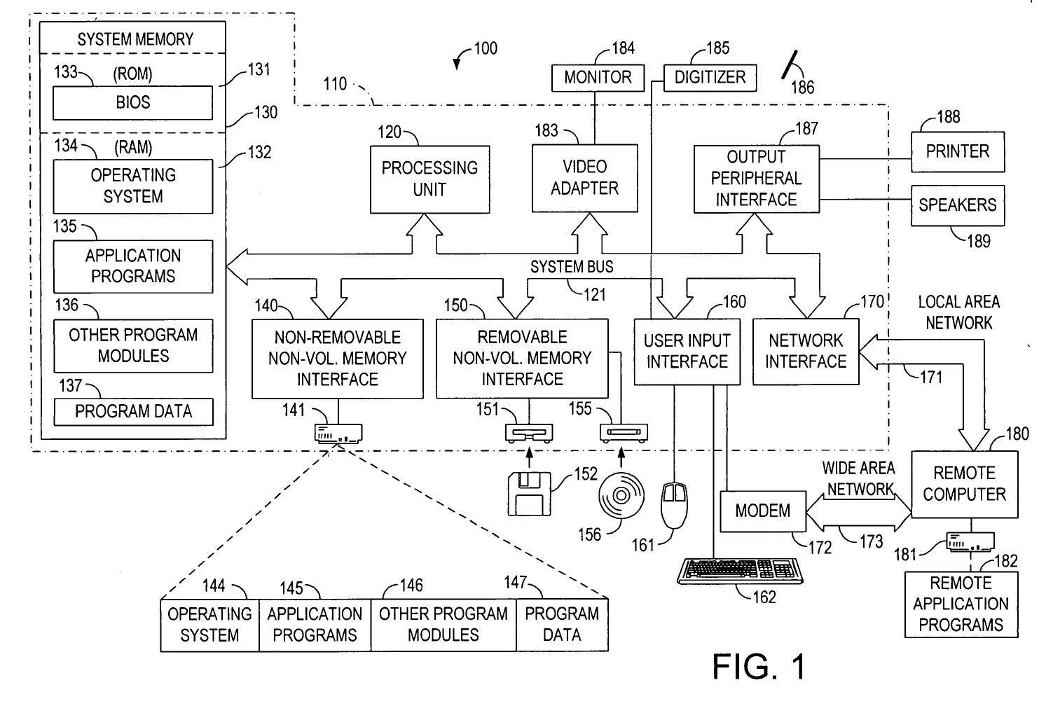

FIG. 1 illustrates an example of a suitable computing system environment 100 in which the invention may be implemented. The computing system environment 100 is only one example of a suitable computing environment and is not intended to suggest any limitation as to the scope of use or functionality of the invention. Neither should computing environment 100 be interpreted as having any dependency or requirement relating to any one or combination of components illustrated in illustrative operating environment 100.

Aspects of the invention may be operational with numerous other general purpose or special purpose computing system environments or configurations. Examples of well known computing systems, environments, and/or configurations that may be suitable for use with the invention include, but are not limited to, personal computers (PCs); server computers; hand-held and other portable devices such as personal digital assistants (PDAs), tablet PCs or laptop PCs; multiprocessor systems; microprocessor-based systems; gaming consoles; set top boxes; programmable consumer electronics; network PCs; minicomputers; mainframe computers; distributed computing environments that include any of the above systems or devices; and the like.

Aspects of the invention may be described in the general context of computer-executable instructions, such as program modules, being executed by a computer. Generally, program modules include routines, programs, objects, components, data structures, etc. that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

With reference to FIG. 1, illustrative computing system environment 100 includes a general purpose computing device in the form of a computer 110. Components of computer 110 may include, but are not limited to, a processing unit 120, a system memory 130, and a system bus 121 that couples various system components including system memory 130 to processing unit 120. System bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Advanced Graphics Port (AGP) bus, and Peripheral Component Interconnect (PCI) bus, also known as Mezzanine bus.

Computer 110 typically includes a variety of computer readable media. Computer readable media can be any available media that can be accessed by computer 110 such as volatile, nonvolatile, removable, and non-removable media. By way of example, and not limitation, computer readable media may include computer storage media and communication media. Computer storage media may include volatile, nonvolatile, removable, and non-removable media implemented in any method or technology for storage of information such as computer-readable instructions, data structures, program modules or other data. Computer storage media includes, but is not limited to, random-access memory (RAM), read-only memory (ROM), electrically-erasable programmable ROM (EEPROM), flash memory or other memory technology, compact-disc ROM (CD-ROM), digital video disc (DVD) or other optical disk storage, magnetic cassettes, magnetic tape, magnetic disk storage or other magnetic storage devices, or any other medium which can be used to store the desired information and which can accessed by computer 110. Communication media typically embodies computer-readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, radio frequency (RF) such as BLUETOOTH standard wireless links, infrared and other wireless media. Combinations of the any of the above should also be included within the scope of computer readable media.

The system memory 130 includes computer storage media in the form of volatile and/or nonvolatile memory such as ROM 131 and RAM 132. A basic input/output system (BIOS) 133, containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates software including operating system 134, application programs 135, other program modules 136, and program data 137.

Computer 110 may also include other computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD-ROM, DVD, or other optical media. Other computer storage media that can be used in the illustrative operating environment include, but are not limited to, magnetic tape cassettes, flash memory cards, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer-readable instructions, data structures, program modules and other data for computer 110. In FIG. 1, for example, hard disk drive 141 is illustrated as storing an operating system 144, application programs 145, other program modules 146, and program data 147. Note that these components can either be the same as or different from operating system 134, application programs 135, other program modules 136, and program data 137, respectively. Operating system 144, application programs 145, other program modules 146, and program data 147 are given different numbers in FIG. 1 to illustrate that, at a minimum, they are different copies.

A user may enter commands and information into computer 110 through input devices such as a keyboard 162 and pointing device 161, commonly referred to as a mouse, trackball or touch pad. Each of these devices may include a plurality of input components, each providing its own input. In the case of a keyboard, each of the keys or specialized buttons may serve as input components. Moreover, a key combination may serve as a unique input component, such as a user modifying a key entry by holding a combination of the Control, Alt, Shift or other keys simultaneously. In the case of a mouse, trackball, or other pointing device, in addition to the position information each provides, input components may include the buttons, wheels, or other input mechanisms encased in the device.

Other classes of input devices, each having its own concept of an input component, have been conceived, allowing for new and diverse modes of user input. For example, systems requiring no physical contact by a user may be able to track the gestures, body movements, or even eye movements of a user. For such systems, each gesture or movement by the user may be interpreted as a different input component. For example, a camera, magnet, or other sensing component (not shown) attached to computer 110 may track hand and body motions of a user, and associated software may interpret separate input components depending on the location, path, and/or timing of a particular gesture. Another example of a next generation input device is a voice recognizer, which may use a microphone and associated software to interpret voice and sound commands as input components.

Additional input devices (not shown) may include a microphone, joystick, game pad, scanner, or the like. These and other input devices are often coupled to processing unit 120 through a user input interface 160 that is coupled to system bus 121, but may be connected by other interface and bus structures, such as a parallel port, game port, universal serial bus (USB), or IEEE 1394 serial bus (FIREWIRE). A monitor 184 or other type of display device is also coupled to the system bus 121 via an interface, such as a video adapter 183. Video adapter 183 may comprise advanced 2D or 3D graphics capabilities, in addition to its own specialized processor and memory.

Computer 110 may also include a digitizer 185 to allow a user to provide input using a stylus 186. Digitizer 185 may either be integrated into monitor 184 or another display device, or be part of a separate device, such as a digitizer pad. Computer 110 may also include other peripheral output devices such as speakers 189 and a printer 188, which may be connected through an output peripheral interface 187.

Computer 110 may operate in a networked environment using logical connections to one or more remote computers, such as a remote computer 180. Remote computer 180 may be a personal computer, a server, a router, a satellite relay, a network PC, a peer device or other common network node, and typically includes many or all of the elements described above relative to computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, computer 110 is coupled to the LAN 171 through a network interface or adapter 170. When used in a WAN networking environment, computer 110 may include a modem 172, a satellite dish (not shown), or another device for establishing communications over WAN 173, such as the Internet. Modem 172, which may be internal or external, may be connected to system bus 121 via user input interface 160 or another appropriate mechanism. In a networked environment, program modules depicted relative to computer 110, or portions thereof, may be stored remotely such as in remote storage device 181. By way of example, and not limitation, FIG. 1 illustrates remote application programs 182 as residing on memory device 181. It will be appreciated that the network connections shown are illustrative and other means of establishing a communications link between the computers may be used.

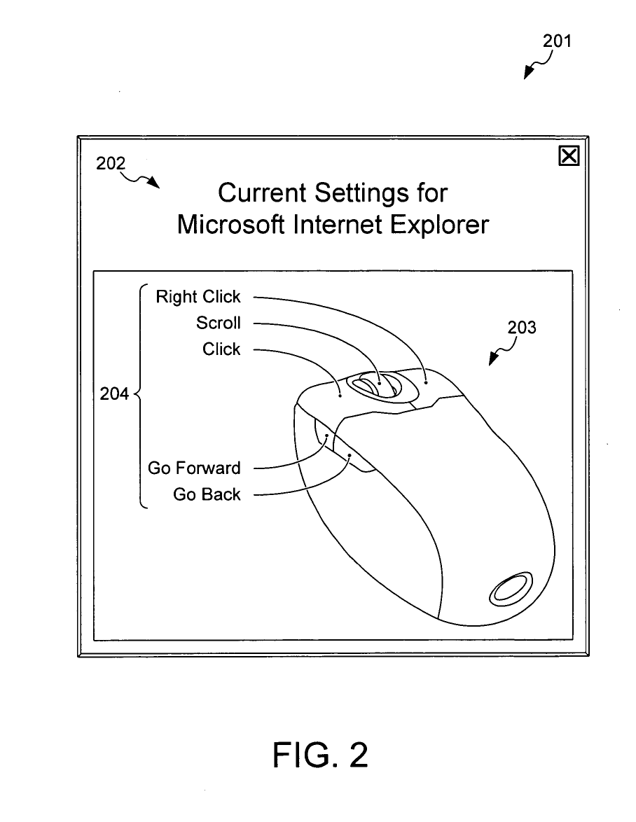

FIG. 2 depicts dialog box 201 displayed by one or more illustrative embodiments of the invention. Dialog box 201 displays feedback about an input device, which in this example is the set of actions 204 currently assigned to the input components of a mouse 203. Message 202 provides feedback about the current state of the assignments and/or identifies the type of information provided to the user. Such a dialog may be used in more than one embodiment of the invention. A user may request to view the current actions assigned to a selected input device. This request may come in the form of, for example, launching a particular application or control setting, selecting a function from a menu, or triggering a particular hotkey. The dialog may also be displayed in response to the assignment of a particular action to a particular input component. For example, the scroll wheel of mouse 203 may have just been reassigned from being a zoom controller to a scroll controller, and dialog box 201 is displayed in response to the reassignment. Such an assignment may have been triggered by the user through a particular application or control setting. Alternatively, the assignment may have been triggered by the computer, as set forth below in some detail.

Dialog box 201 provides the user with feedback about the current settings on a selected input device, which in the present example is mouse 203. The feedback provided assists a user of the associated computer in learning about additional, possibly unknown, input device functionality. For example, a user may not realize that the front and rear side buttons on mouse 203 may be used to go forward or back when browsing in a web browser or similar application. Dialog box 201 provides information or even reinforcement for the user about how the input device may be used to make computer input more productive.

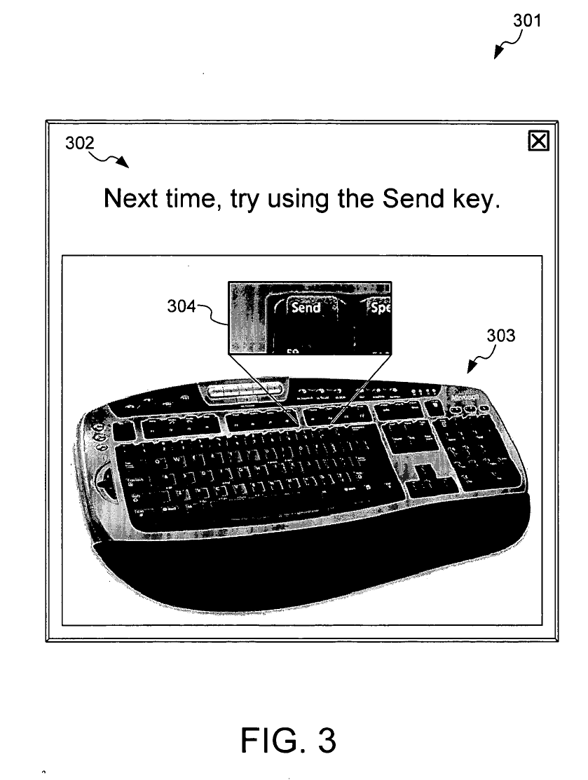

FIG. 3 depicts feedback dialog box 301 displayed by one or more illustrative embodiments of the invention. Software installed on a computer may monitor how a user utilizes the input devices coupled to or part of the computer. In this example, a user may have been composing an email using a keyboard, and then reached over to use a mouse to point at a displayed “Send” button and click it. The software may keep track of alternate inputs that may achieve the same or a related outcome. Since the user is using the keyboard, it may be more productive for the user to use a specialized key on the keyboard to send the email, rather than wasting time reaching for and repositioning the mouse. The software, upon making this determination, displays dialog box 301 to inform the user about the alternate input. Dialog box 301 includes message 302, letting the user know that next time, she should try using the “Send” key on the keyboard. Dialog box 301 presents a keyboard image 303 of the keyboard model in use, making it easier for the user to find the send key. The particular key is zoomed in callout 304, giving the user an exact location of the key. By providing both the graphical and textual lesson, the user receives reinforcement about the optimal input. In order to provide further reinforcement, an audio message may accompany the display of dialog box 301. Other forms of feedback are possible, including tactile feedback.

In order to make decisions about whether an alternate input is more optimal, the software may store input device usage data. Such data may be stored in a database, which may be in the form of a flat file, a relational database, an object database, or other form of database. The database may include a table having entries for each use of an input device. Each entry in such a table may include and associate together, by way of example and not limitation, a user identifier, a timestamp, a context (e.g., Windows® Explorer, Microsoft Word®, Textbox Control, etc.), an input device, an input component identifier (i.e. which key, combination of keys, or button on the input device was pressed, or which gesture was sensed), and/or an action performed. As user inputs are added to the database, the software may search for a pattern of input device usage. Such pattern searching may include, by way of example, looking for the most recently used input device and subsequently recommending an alternate input, on the same input device or a different input device that performs the same action. Upon making a recommendation, the computer may add an entry to the database for tracking recommendations that have been made. Such entries may be used to prevent overly repetitive messages, and also to track the effectiveness of the feedback in changing behavior.

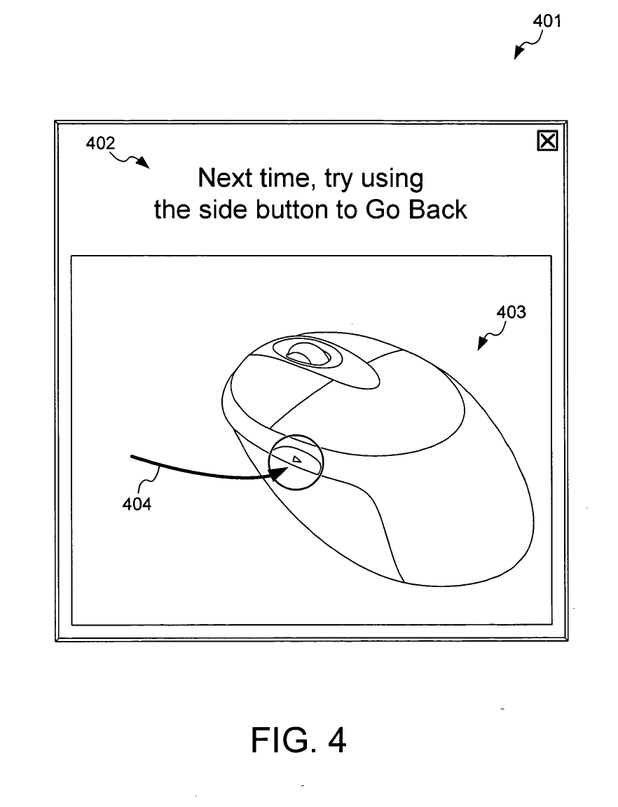

FIG. 4 depicts feedback dialog box 401 displayed by one or more illustrative embodiments of the invention. Here, the software has determined that an alternate input for “Go Back” is the side button on an attached mouse. A user may have been using the mouse to browse a web page, but was frequently wasting time repositioning the mouse and clicking “Back” to go back in the browser's history. The software determines that a more optimal way of doing this is to use the side button on the mouse. If the “Go Back” action was not previously assigned to the mouse side button, the software may perform this assignment automatically. By searching for patterns of usage, the software may determine, for example, that the user never uses the side mouse button for the action previously assigned to it. Alternatively, the software may be able to query the operating system or an application to determine that no action has been assigned to the mouse side button at all. In response to either of these determinations, the software then assigns the “Go Back” action to the button and displays feedback message 402, along with mouse image 403. Callout 404 directs the user to the exact location of the side button. However, if the software determines that the user has previously or recently used the mouse side button, or that the mouse side button has a previous assignment, then in response the software may decide not to reassign the mouse side button. In this latter case, the software may determine a different input component to assign to the “Go Back” action, or the software may display a dialogue asking the user whether it is okay to reassign the mouse side button. Such assignments may be context dependent, working only when they are applicable. For example, the assignment of “Go Back” to a side mouse button may apply globally for the operating system and all applications, or the assignment may apply only in the context of web browsing applications.

It should be noted that mouse image 403 displays a different type of mouse from the mouse image 203 of FIG. 2. The software is able to access information about the input devices attached to a computer. This information may be provided by a database of possible input devices which may in turn be provided with the software, or may be accessible over a network such as the Internet. Users may then select their hardware from a list. This information may also be derived from plug and play device information stored for use by the operating system. The recommendations may be more accurate where the software has access to information about the attached input devices and the input components each device provides. Moreover, the images displayed in feedback dialog 401 may provide better familiarization with enhanced input components if the user can see the exact location of a button or key on their particular input device.

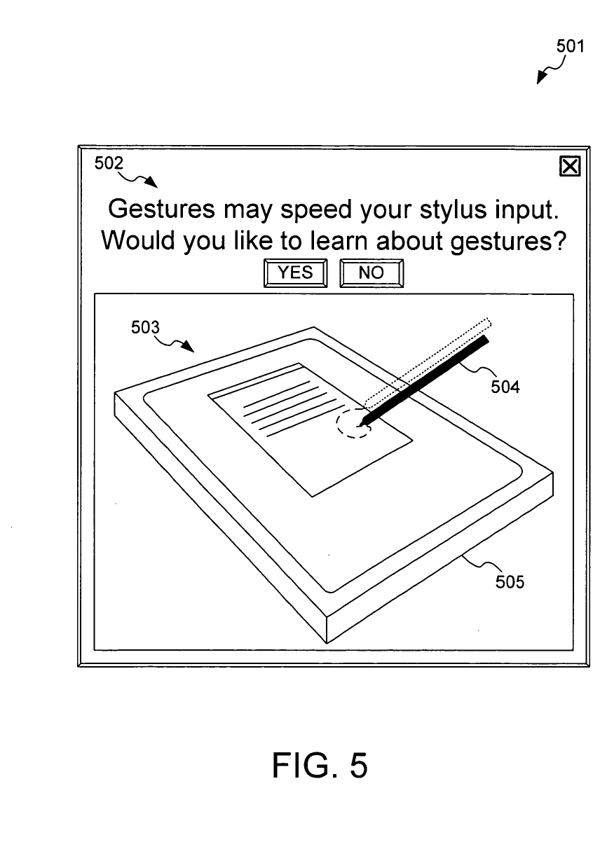

In addition to providing information about alternate inputs, a user may be directed to receive more information about a particular alternate input through the use of on-screen video or training software. FIG. 5, for example, depicts feedback dialog box 501 displayed by one or more illustrative embodiments of the invention. Here, feedback dialog box 501 issues a message 502, asking the user if they would like to get more information on an alternate means of input, for example, stylus gestures. The dialog box 501 may also display an animation 503 of stylus 504 performing a gesture over tablet computer 505. If a user clicks “No,” then the dialog is closed. If the user clicks “Yes,” they may be shown a video or other training program to teach them about the alternate means of input. Training may be available for all forms of input devices, and the content of the training programs may be provided with software accompanying a device, or via the Internet. Whether a user clicks “Yes” or “No,” the response may be stored for analysis of feedback effectiveness.

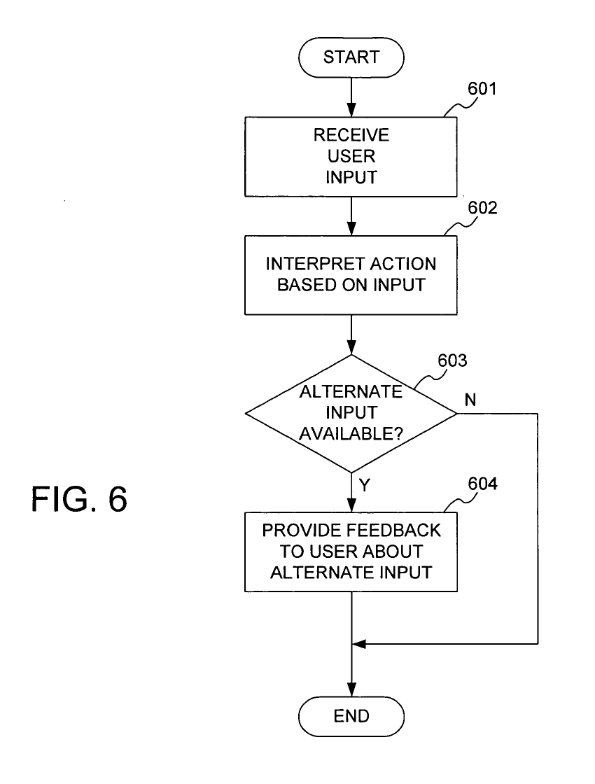

FIG. 6 is a flowchart of an illustrative method for providing input device training to a user according to one or more embodiments of the invention. The illustrative steps provided are not exclusive, nor are they necessarily restricted to the order provided. At step 601, an input is received from an input device, whether a mouse click, a key tap, or some other input component. An input component may include key combinations on a keyboard, such as Control-C or Shift-Enter. The input may be received directly, or may first be processed by an operating system or device driver and passed on. The input, at step 602, is interpreted for the action it is meant to perform. For example, if the “A” key is tapped on a keyboard, then the letter “A” may be displayed or otherwise acted upon by whichever application currently receiving input. As another example, the “A” may be used to select an item in a list, or an option in a menu. Regardless, an action may be interpreted either by an application or an operating system and information about the interpreted action is collected.

At decision 603, a determination is made as to whether an alternate input is available. Such a determination may be made solely on the single input provided and the action interpreted. It may be inherently more efficient to, for example, click the “Send” key on a keyboard rather than reposition and click a mouse. Alternatively, previous input device usage data may be used in making the determination of step 603, in order to recognize patterns of usage. Upon detecting a more suitable or otherwise different input component that performs the same or a related action, a recommendation may be appropriate. In one or more embodiments of the invention, however, a user may control the feedback provided and, in order to reduce annoyance, set a threshold level for when feedback dialogs are displayed. As such, an additional component of decision 603 is determining whether the recommendation meets a user's threshold criteria.

If an alternate input is available, then at step 604 feedback is provided to the user about the alternate input. This feedback may be in the form of a displayed dialog, such as in FIGS. 3 or 4. The feedback may additionally or alternatively take another form, with other visual, audio, or tactile feedback alerting the user to the available input. For example, an image of the input device may be displayed, while the recommendation, such as “Next time, try the side mouse button to go back,” may be read aloud by a synthesized voice. In addition, a user may be provided with an option to ignore future recommendations.

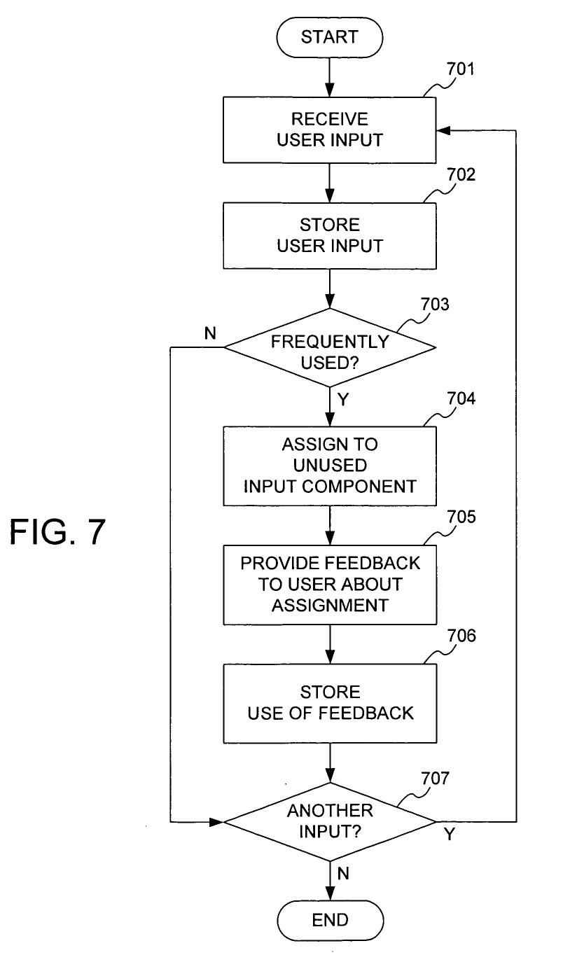

FIG. 7 is a flowchart of an illustrative method for assigning a frequently used interaction according to one or more embodiments of the invention. As before, the steps provided are not exclusive, nor are they restricted to the order provided. At step 701, a user input is received. As in step 601 in FIG. 6 above, the input may first be received by an application or an operating system and passed on. The input may also be interpreted for the intended action. At step 702, the input is stored in a database for analysis. This may involve placing an entry in a database table for the input. At decision 703, a determination is made as to whether the interaction is frequently used. A frequently used interaction may include, for example, a repeated single input or a repeated combination of inputs. For example, a user may constantly type Control-B followed by Control-I on a keyboard, possibly to make text bold and italicized respectively. If a particular input is performed at a sufficient rate, such as by exceeding a threshold number of times the input is performed per given time period), then the input may be considered to be a frequently used interaction. Although Control-B and Control-I may individually be frequently used interactions, the combination of these inputs may also be considered a frequently used interaction. By analyzing previously recorded inputs, and looking for patterns of interactions, one or more embodiments of the invention may determine whether a received interaction is a frequently used interaction worthy of assignment to an unused key, button, key combination, or other input component.

If a frequently used interaction is determined, then at step 704, the interaction is assigned to an unused input component. Using the example above, if it is determined that the combination of Control-B and Control-I is frequently used then the interaction may be assigned to an unused (or underutilized) mouse button, key, combination of keys, or other input component. In determining the best selection of an unused input component, a set of unassigned input components may be utilized. Such a set may be maintained in a database, be maintained by an application or the operating system, or may be determined and generated dynamically upon each assignment. In addition, a list of assigned but unused or underutilized input components may be maintained or generated dynamically based on the user input data stored in the database. If a user never (or infrequently) uses a particular key combination or button, for example, then it may be a candidate for assignment. Once all available input components are determined, then selecting an available input component may entail determining which would be most efficient for the user. This determination may involve examining input device usage patterns and determining which is most optimal or otherwise the most preferred, as described above.

The determination of whether a particular interaction is frequent enough may be determined in any number of ways. A preset number may be set within the application or the number of occurrences of an interaction may be set by a user in a control setting or within an application.

Once an assignment is made, at step 705, feedback is provided to the user about the assignment. This may entail displaying a dialog similar to those described above, letting the user know that a new assignment was created, and displaying the location of the input component. Optionally, a user may be provided with a choice of approving or declining the assignment.

Once the assignment of a frequently used interaction to an unused input component is made, and feedback is provided, then at step 706, information about the displayed feedback is stored, along with any optional data, such as whether the assignment was declined. This data may later be used to analyze the assignment of input components, the feedback provided, and whether a user actually learned to use the newly assigned input. If there are additional inputs, then at decision 707 the steps repeat beginning at step 701.

While the invention has been described with respect to specific examples including presently preferred modes of carrying out the invention, those skilled in the art will appreciate that there are numerous variations and permutations of the above described systems and methods that fall within the spirit and scope of the invention as set forth in the appended claims. A claim element should not be interpreted as being in means-plus-function format unless the phrase “means for”, “step for”, or “steps for” is included in that element. Also, numerically-labeled steps in method claims are for labeling purposes only and should not be interpreted as requiring a particular ordering of steps.

What is claimed is:

1. A computer-implemented method for providing input device training to a User, the method comprising:
receiving an input from an input device directed to a computer;
interpreting an action based on the input;
determining an alternate input for the action; and
providing feedback about the alternate input to the user.

2. The method of claim 1, wherein providing feedback about the alternate input to the user comprises displaying a dialog on a display associated with the computer.

3. The method of claim 1, further comprising:
customizing the feedback for the input device to which the alternate input can be directed.

4. The method of claim 3, wherein customizing the feedback for the input device comprises displaying an image of at least a portion of the input device.

5. The method of claim 1, further comprising:
storing data representing a plurality of inputs provided by the user.

6. The method of claim 5, wherein storing data about a plurality of inputs comprises creating an entry in a table for each of the plurality of inputs.

7. The method of claim 5, wherein determining the alternate input for the action comprises determining the alternate input based on the data stored in the table.

8. The method of claim 1, further comprising:
assigning the action to the alternate input.

9. The method of claim 1, wherein the input is a mouse input and the alternate input is a keyboard input.

10. A computer-readable medium storing computer-executable instructions for performing the steps recited in claim 1.

11. A computer-implemented method for assigning a frequently used interaction, the method comprising:
determining a plurality of unused input components;
searching a plurality of stored inputs for a frequently used interaction; and
assigning the frequently used interaction to one of the plurality of unused input components.

12. The method of claim 11, wherein the plurality of unused input components comprises unused keyboard buttons.

13. The method of claim 11, wherein the plurality of unused input components comprises unused mouse buttons.

14. The method of claim 11, wherein the plurality of unused input components comprises unassigned keyboard shortcuts.

15. The method of claim 11, wherein the frequently used interaction comprises a frequent clicking of a computer-interface object with a pointing device.

16. The method of claim 15, wherein the unused input component to which the frequently used interaction is assigned comprises a keyboard shortcut.

17. The method of claim 11, wherein the frequently used interaction comprises a frequently used series of inputs.

18. The method of claim 11, wherein determining the plurality of unused input components comprises analyzing the plurality of stored inputs for unused input components.

19. A computer-readable medium storing computer-executable instructions for performing the steps recited in claim 11.

20. A system for providing input device training, the system comprising:
an input device;
a display device;
a database; and
a processor, coupled with the input device, the display device, and the database, wherein the processor is configured to perform the steps of receiving an input from the input device, interpreting an action based on the input, storing the input and the action in the database, searching the database for a pattern of input device usage, determining an alternate input that accomplishes the action, and displaying feedback about the alternate input on the display device.
